(19) United States
(12) Patent Application Publication
(10) Pub. No.: US 2007/0268488 A1
(43) Pub. Date: Nov. 22, 2007

(54) Target acquisition attachment for portable spectrophotometer

(76) Inventor: Michael J. McAllister, Malvern, PA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/799,996

(22) Filed: May 3, 2007

Related U.S. Application Data
(60) Provisional application No. 60/802,421, filed on May 22, 2006.

(51) Int. Cl. G01J 3/42

(52) U.S. Cl. 356/319

(57) ABSTRACT

A target acquisition attachment device for the accurate handheld spectrophotometric measurement of small samples or samples of particular areas of larger objects, having an orifice in its base plane of precise location and size that will properly align with the aperture of the handheld spectrophotometer. The alignment occurs when the target device is first placed over the small sample and subsequently, the handheld spectrophotometer is placed within the peripheral dimensions of the target device. This alignment of the handheld spectrophotometer's aperture within the peripheral dimensions of the small sample can be achieved even when the sample becomes no longer visible to the spectrophotometer operator due to the handheld spectrophotometer's placement over the small sample being targeted for measurement.

### CROSS-REFERENCE TO RELATED APPLICATION

This application claims the benefit of U.S. Provisional Application Ser. No. 60/802,421 filed on May 22, 2006 which is hereby incorporated by reference in its entirety.

### BACKGROUND OF THE DISCLOSURE

The disclosure generally relates to spectrophotometric analysis of solid samples comprising coating materials. Frequently the coating has been applied to the surface of a small chip comprised of materials which form substrates to which the coatings will be applied in actual usage, such as automotive and truck bodies or panels comprising components of prefabricated structures. More particularly, the disclosure relates to an attachment that acquires a small sample target so that spectrophotometric analyses of such samples may be made rapidly, reliably and with reliably replicable results.

A spectrophotometer is a laboratory instrument used to characterize the color of the surface of an object. In so doing, it may also produce useful data about consistency and uniformity of the color on the object's surface. A handheld spectrophotometer can provide its operator the ability to measure the color of a small sample or, of a larger object, a sample of an entire area. In measuring the color of an area, the handheld spectrophotometer affords the operator portability, mobility and a great deal of latitude in being able to choose the specific site within a sample area for the color reading. In addition, a laboratory is not needed, so that effective testing may be accomplished in nearly any setting.

A variety of spectrophotometers, including portable instruments, are known in the art and these are commercially available from well known sources. Generally, spectrophotometers use a monochromator or polychromator as a source of emitted light, and one or more photodetectors for receiving incident light from a sample. The incident light is received, processed and analyzed. Skilled artisans can use the analysis data to determine color, and chemical and physical characteristics of color, to test samples for fidelity to standards and consistency of quality, among other important characteristics.

Spectrophotometric analysis of a small sample of less than two square inches becomes problematic if the sample is smaller than the footprint of the handheld spectrophotometer. Samples of small sizes are commonly used in the coating industry. They are often referred to as “chips” and may not be larger than a typical postage stamp or a coin, such as a quarter. There is a trend in the industry to develop and use ever smaller sample chips. The color of the small sample can be readily measured if the lens aperture of the handheld spectrophotometer can be properly aligned within the peripheral dimensions of the small sample. This is actually very difficult as the small sample must be beneath the handheld spectrophotometer and must also be precisely aligned. Positioned underneath the instrument, the sample is obscured from the operator's view and therefore the operator cannot be certain that the aperture of the spectrophotometer is aligned within the perimeter of the sample. This uncertainty leads to wasteful expenditures of time and erroneous measurements, many of which, are not immediately recognized as inaccurate or imprecise. Faulty measurements create bad color formulations and directly result in lost productivity and material waste. Ultimately, this may lead technicians and analysts to conclude that a handheld spectrophotometer is unreliable. Accordingly, there is a need for a device that allows for rapid and reliable sample target acquisition, i.e., precise alignment of the aperture of the portable spectrophotometer within the peripheral dimensions of the sample.

The present attachment device meets this need in that it provides the means to target a small sample so that the handheld spectrophotometer's aperture can be properly and readily aligned within the peripheral dimensions of a small sample beneath its footprint. Use of this handheld spectrophotometer target device can reduce color measurement time while significantly increasing measurement accuracy and operator confidence.

A three-dimensional template attachment is known in the art, and is commercially available from GretagMacbeth and is adapted for use with that company's ColorEye® XTH hand-held spectrophotometer. It is especially useful for three-dimensional samples that can be inserted within a sample tray provided with one particular attachment. Otherwise, it is useful for analyzing rather larger samples, such as a hand-held calculator case or a portion of the surface of a home appliance. A need still exists, however, for an attachment that will enable operators to quickly and reliably test small sample chips and the like. The present attachment device addresses that need.

The advent of the spectrophotometer as a laboratory color measurement tool predates development of the handheld spectrophotometer and by design does not generally require a target device to direct and align its aperture within the peripheral dimensions of a small sample as does the handheld spectrophotometer. Laboratory color measurement in this sense may be considered to be distinct from the present field in this respect.

### SUMMARY OF THE DISCLOSURE

This disclosure is directed to a detachable target acquisition attachment for a portable spectrophotometer having an aperture for passage therethrough of emitted light from the spectrophotometer and incident light from a target sample, comprising a base plane with at least one aperture, at least alignment member attached to the base plane, wherein the alignment members engage the spectrophotometer to cause the attachment and the spectrophotometer to remain associated, and the aperture of the spectrophotometer and the at least one aperture of the horizontal plane to be coaxially aligned while the attachment and spectrophotometer remain associated.

The disclosure also provides an attachment comprised of a material that at least substantially does not absorb emitted or incident light, or alternatively or in addition, comprises a coating that at least substantially does not absorb emitted or incident light.

The alignment members may be side or track members of varying height and thickness. The members may be fixedly attached to the horizontal plane, or moveably attached as by optional hinge means. The attachment may further comprise disengageable detent means for more securely associating the, attachment with the spectrophotometer.

There is also provided optional integral magnetic means for the horizontal plane and/or the aperture or apertures.

In other embodiments, the horizontal plane and/or one or more alignment members may be molded to conform to the topography of the surface of the spectrophotometer adjacent thereto.

The attachment may be made from essentially any material that may be stamped, molded or formed. In some embodiments, the target acquisition attachment is comprised of a moldable or thermoformable polymer.

### BRIEF DESCRIPTION OF THE FIGURES

Other objects and advantages will become apparent from a study of the following specification when viewed in light of the accompanying drawing, in which:

FIG. 1 is a side plan view of a handheld spectrophotometer when it is precisely accommodated by a target acquisition attachment device;

FIG. 2 is a perspective view of a target a target acquisition attachment prior to its application to a handheld spectrophotometer to measure color within the dimensions of a small sample.

FIG. 3 depicts an embodiment of an attachment having a base plane and three alignment members.

FIG. 4 depicts the base plane aspect of a handheld spectrophotometer and its contours.

FIG. 5 illustrates “concave” and “convex” alignment members.

### DETAILED DESCRIPTION OF THE DISCLOSURE

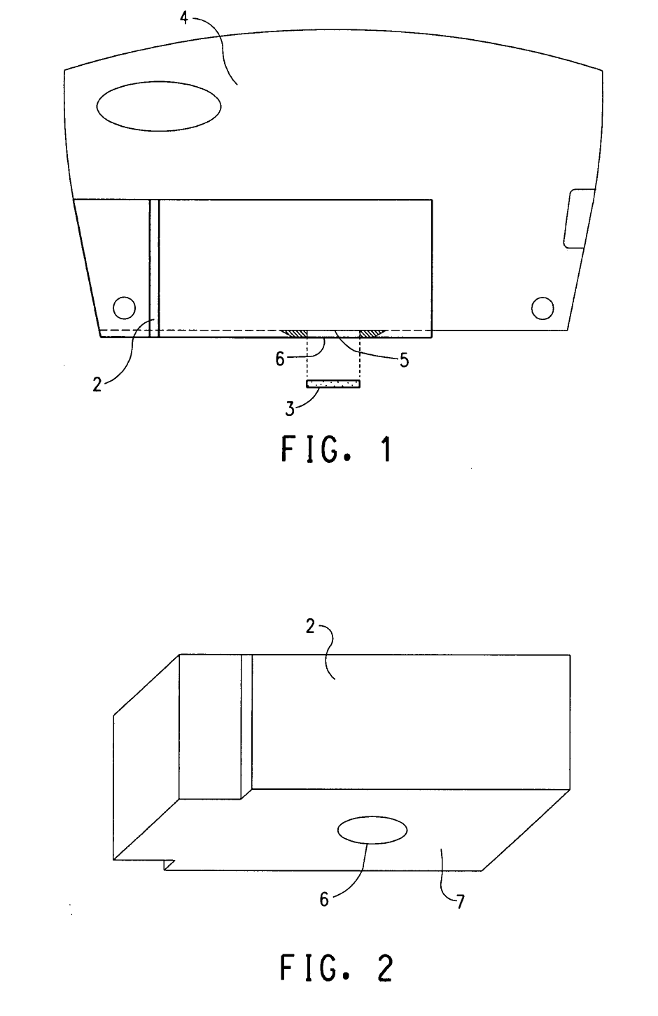

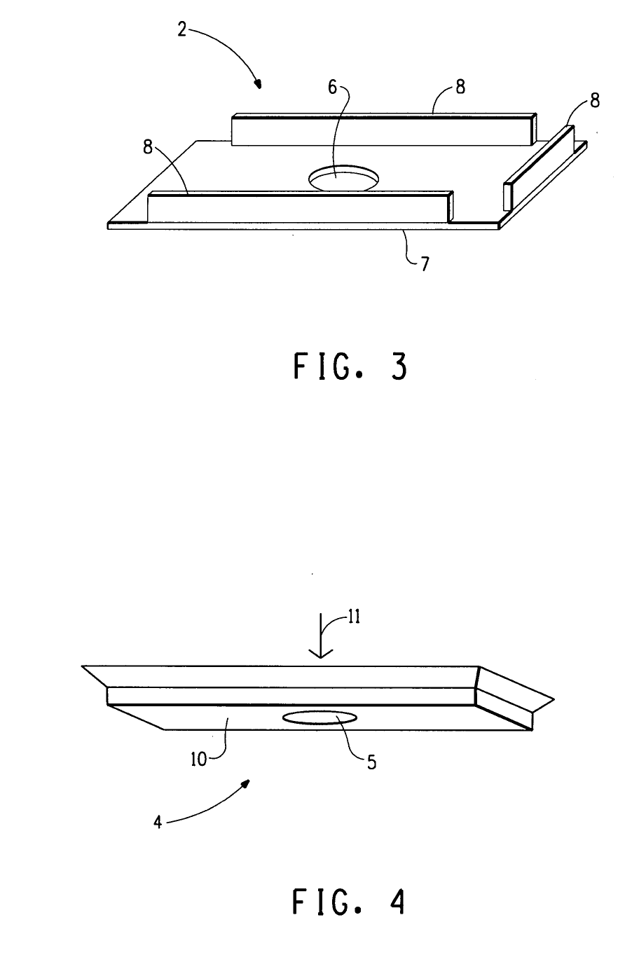

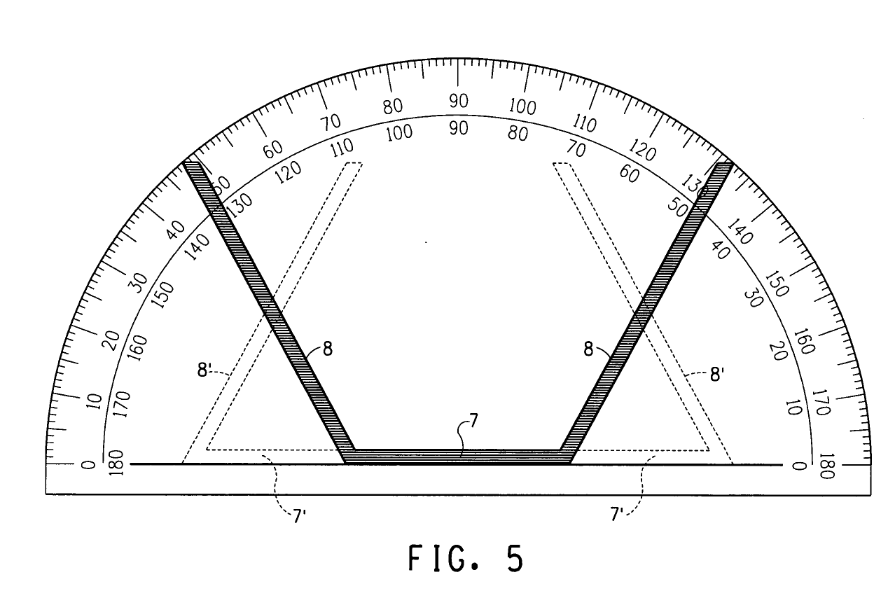

Referring first to FIGS. 1 and 2 of the drawings, a handheld spectrophotometer 4 is shown in FIG. 1 with a target acquisition attachment 2 connected thereto. The aperture 5 of the spectrophotometer 4 is aligned with the orifice 6 of the attachment, in place to take a test reading on sample chip 3. FIG. 2 shows an attachment 2 separate from a spectrophotometer with an orifice 6, base plane 7 and side alignment member 8. In this embodiment, two side alignment members are longer than a third (front aspect) alignment member, and each is connected substantially perpendicularly to the base plane 7. In FIGS. 1-3, the base plane 7 is flat. In FIG. 4, a base plane of a target acquisition attachment may be shaped to conform to the outer surface contours of the handheld spectrophotometer as shown. The base plane aspect 10 of the spectrophotometer 4 (not shown in its entirety) is the surface of the instrument associated with, and adjacent to, or proximal to, the base plane 7 of an attachment 2 when they are engaged, or associated, for testing samples. Marking 11 is a positional arrow on the spectrophotometer 4 to indicate that the aperture 5 is located at the same relative position on the base plane aspect 10 of the instrument. FIG. 5 shows a “concave” arrangement of two side aspect alignment members 8 in relation to a flat base plane 7 of an attachment 2. In this arrangement, one alignment member is approximately 50° from the horizontal, the other is approximately 130° from the horizontal. An alternative, convex, arrangement would have an elongated base plane 7′ and side alignment members 8′ canted toward each other as shown. It is not necessary that the angles at which parallel side alignment members lie in relation to the horizontal be equal, or supplementary, though those skilled in the art will appreciate that having plane angles that are substantially equal will, in most applications of the attachment, be preferred. FIGS. 1 and 2 exemplify a “wall” type alignment member 8 while FIG. 3 exemplifies a “track” type alignment member 8. It will be appreciated that variations on these configurations will be useful for the intended purposes.

The orifice 6 can be any shape, including a shape that substantially conforms to the peripheral shape of the sample chip 3. The orifice 6 may be made so that its surface area is slightly smaller than the periphery of the sample 3 and shaped so that the entire periphery of the orifice fits inside the periphery of the sample to avoid receiving incident light from a surface other than that of the sample chip 3. Where necessary or desired, the orifice size or shape may be modified with an overlaying member having its own orifice 6′ (not shown) whose periphery, in whole or in part, will lie within the periphery of the orifice 6 of the attachment. In certain embodiments, the area of the opening of orifice 6 (or optional overlaid orifice 6′, not shown) of base plane 7 is sized so that the aperture 5 of spectrophotometer 4 ranges from about 1.1 to about 2 times the size of the orifice area. Providing an orifice 6 whose area is thus smaller than the area of the opening of aperture 5 assures that the surface area of the sample to be analyzed will be from about 50% to about 91% of the size of aperture 5. The base plane 7 or the periphery of the orifice 6 may be provided with magnetic means to engage complementary magnetic means on the periphery of a sample 3 or metallic sample chips 3 which are inherently magnetic. Alternatively, clip means may be affixed to the periphery of the orifice 6 to provide a structure in which samples 3 may be reposed in proper alignment for testing. A clip is any device, such as a folded metal or plastic piece that is open at one end, wherein an item such as a sample chip 3 can be inserted in the open end and held in place by friction.

The base plane 7 will preferably be as thin as possible while still allowing for acceptable mechanic strength to maintain the integrity of its shape and that of the periphery of orifice 6, and also maintain any factory specification focal length for the instrument. It is also desirable that the base plane 7 be sufficiently rigid to allow for the alignment members 8 to be attached thereto with sufficient rigidity to maintain the shape and size of the attachment 2 as a whole. Minimal thickness of the base plane 7 is generally desired to provide a strong signal of incident light from the sample to the photodetectors of the spectrophotometer 4, to avoid loss by absorption or attenuation due to unnecessary thickness of the base plane. In some embodiments, the alignment members 8 may be attached by means such as hinges that permit the alignment members to be folded for ease of storage. In yet further embodiments, the hinge means may be spring biased to hold side alignment member planes 8 against the adjacent outer surfaces of spectrophotometer 4.

The alignment members may also be provided with means, complementary to those on one or more surfaces of the spectrophotometer 4 that enable the attachment 2 to secure in locking engagement to the spectrophotometer, provided such means are releasable. Tongue in groove, slot, snap, magnet, or mechanical detent means, or adhesive means including VELCRO and the like are suitable. In addition, friction engagement, including friction engagement enabled by conforming to the shape of the attachment to the contours of one or more aspects of the spectrophotometer 4 may be desirable. Such attachment means enable the operator to keep the orifice 6 of the target acquisition attachment 2 in precise alignment with the aperture 5 of the spectrophotometer 4 without having to make repeated visual checks to assure proper alignment.

The base plane 7 and alignment members 8 may be made from any material that may be shaped by stamping, molding or forming. A moldable or thermoformable polymer would comprise a suitable material. The material itself may be non-absorptive of emitted or incident light. In addition, or alternatively, the material may be coated with one or more coating materials that are non-absorptive of emitted or incident light.

The foregoing is given by way of illustration, and not limitation. Variations on these will occur to those skilled in the art, and are not meant to be excluded from the scope of the claims that follow.

What is claimed is:

1. A target acquisition attachment for a portable spectrophotometer having an aperture for passage of emitted light and incident light from a target sample, comprising:
a base plane having at least one alignment member attached thereto wherein;
the alignment member or members engage the spectrophotometer such that the attachment and the spectrophotometer stay connected while the spectrophotometer is in use; and wherein
an orifice provided in the base plane is coaxially aligned with an aperture of the spectrophotometer to permit passage of emitted and incident light therethrough.

2. The attachment of claim 1 comprising a material that is substantially non-absorptive of emitted or incident light.

3. The attachment of claim 1 comprising a coating that is substantially non-absorptive of emitted or incident light.

4. The attachment of claim 1 wherein the area of the aperture ranges from 1.1 to 2 times the surface area of a sample being analyzed by said spectrophotometer during use.

5. The attachment of claim 1 wherein said attachment is made of a moldable or thermoformable polymer.

6. The attachment of claim 1 wherein the alignment members are fixedly attached to the base plane.

7. The attachment of claim 1 wherein the alignment members are attached to the base plane via hinges.

8. The attachment of claims 6 or 7 wherein two alignment members are provided with concave or convex shape in a longitudinal direction in relation to the base plane.

9. The attachment of claim 7 wherein said hinges comprise biased means for improving the engagement of said alignment members to said spectrophotometer.

10. The attachment of claim 1 further comprising clip means on the orifice perimeter for holding a sample in proper alignment during testing.

11. The attachment of claims 1 or 10 wherein the base plane is provided with magnetic means to hold said attachment to the surface of a sample being analyzed by said spectrophotometer during use.

12. The attachment of claim 9 wherein the biased means comprise one or more spring means.

13. The attachment of claim 1 wherein at least one of said base plane or alignment member are provided with attachment means to keep the attachment and spectrophotometer engaged during use.

14. The attachment of claims 1, 10, 11 or 13 wherein the base plane is molded to conform to the topology of the proximal surface of the spectrophotometer.

15. The attachment of claim 14 wherein the side alignment members are molded to conform to the topology of the proximal surfaces of the spectrophotometer.
